(19) United States
(12) Patent Application Publication
(10) Pub. No.: US 2018/0353880 A1
(43) Pub. Date: Dec. 13, 2018

(54) PRE-FILTER DEVICE CAPABLE OF PREVENTING WATER LEAKAGE

(71) Applicant: XIAMEN FILTERTECH INDUSTRIAL CORPORATION, Xiamen (CN)

(72) Inventors: JING-XIAN LIU, Xiamen (CN); YU-TING HU, Xiamen (CN)

(21) Appl. No.: 15/993,217

(22) Filed: May 30, 2018

(30) Foreign Application Priority Data
Jun. 7, 2017 (CN) 201720655316.3

(51) Int. Cl. B01D 35/153

(52) U.S. Cl. CPC B01D 35/153; B01D 29/114; B01D 2201/304; B01D 2201/302

(57) ABSTRACT

a pre-filter device capable of preventing water leakage, that includes: a connector, a water inlet channel, a plug, and a spring. The connector is connected to a water inlet tube, and is connected to the pre-filter device. The water inlet channel is disposed in the connector, and is connected to the pre-filter device. The plug is disposed in the water inlet channel, to open or close the water inlet channel. The spring is disposed between one end of the plug and the connector, the other end of the plug is connected to and acts in cooperation with the pre-filter device. When a pre-filter device capable of preventing water leakage is burst to leak out water, it is able to close the water inlet channel automatically, to avoid the problem deteriorating into flooding the entire household, to achieve timely self protection.

### BACKGROUND OF THE INVENTION

### Field of the Invention

The present invention relates to a filter device, and in particular to a pre-filter device capable of preventing water leakage.

### The Prior Arts

Presently, the pre-filter is the first stage filter in a household to safeguard hygiene and safety of using water, that is used to filter out large particles of mud, sands, rust contained in the water, thus it is used increasingly in our daily life. However, for the pre-filter presently available on the market, it has the problem that, when the pre-filter is burst to leak out water due to mechanical failure or water pressure too high, it is not able to stop water leakage automatically. In case when there is no one at home, or actions are not taken in time, the leaked out water could spread to large area of household, or even flood the entire household to cause severe damages.

Therefore, presently, the design and performance of the pre-filter is not quite satisfactory, and it leaves much room for improvement.

### SUMMARY OF THE INVENTION

In view of the problems and drawbacks of the prior art, the present invention provides a pre-filter device capable of preventing water leakage, to overcome the shortcomings of the prior art.

The present invention provides a pre-filter device capable of preventing water leakage, that includes: a connector, a water inlet channel, a plug, and a spring. The connector is connected to a water inlet tube, and is connected to the pre-filter device. The water inlet channel is disposed in the connector, and is connected to the pre-filter device. The plug is disposed in the water inlet channel, to open or close the water inlet channel. The spring is disposed between one end of the plug and the connector, the other end of the plug is connected to and acts in cooperation with the pre-filter device.

In an aspect of the present invention, the plug includes a movable rod, a water stoppage tight seal ring is sleeved around an outer perimeter of one end of the movable rod, to act in cooperation with the water inlet channel.

In another aspect of the present invention, the pre-filter device capable of preventing water leakage further includes: a press plate, that is disposed between the other end of the movable rod and the pre-filter device.

In a yet another aspect of the present invention, the pre-filter device capable of preventing water leakage further includes a position restricting protrusion block, disposed on the connector, to act in cooperation with the press plate.

In a further aspect of the present invention, the pre-filter device capable of preventing water leakage further includes: a main body, disposed on an opening of the connector; a fixing pad, disposed on the main body; and a lock tight bolt, disposed on the fixing pad.

In a more aspect of the present invention, the pre-filter device capable of preventing water leakage further includes: an air discharge channel, a protrusion ring, a bolt, a tight seal pad, and a cover body. The air discharge channel is disposed on the main body, and is in communication with the water inlet channel. The protrusion ring is disposed on the air discharge channel. The bolt is disposed on an air discharge port. The tight seal pad is connected to one end of the bolt, to act in cooperation with the protrusion ring. The cover body is thread-connected to the other end of the bolt, and is disposed on an outer side of the connector.

In the present invention, the pre-filter device capable of preventing water leakage has the following advantages:

In case the pre-filter device capable of preventing water leakage is burst to leak out water, it is able to close automatically water input at the water inlet end, to prevent the problem from deteriorating into flooding most of the household, while lowering the water leakage rate markedly, in achieving reduction of losses and damages incurred significantly.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram showing water flow for the pre-filter device capable of preventing water leakage in operation according to the present invention;

FIG. 2 is a perspective view of the pre-filter device capable of preventing water leakage according to the present invention; and

FIG. 3 is another perspective view of the pre-filter device capable of preventing water leakage according to the present invention.

### DETAILED DESCRIPTION OF THE PREFERRED EMBODIMENT

The purpose, construction, feature, functions and advantages of the present invention can be appreciated and understood more thoroughly through the following detailed descriptions with reference to the attached drawings.

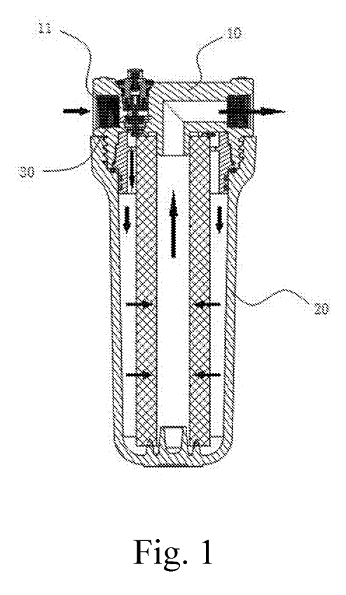

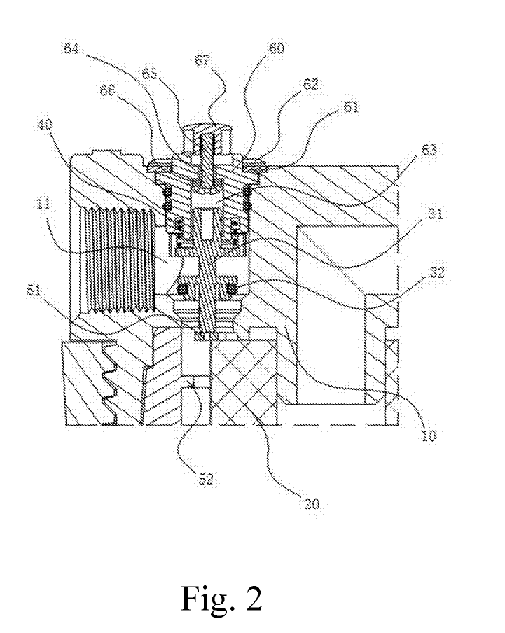

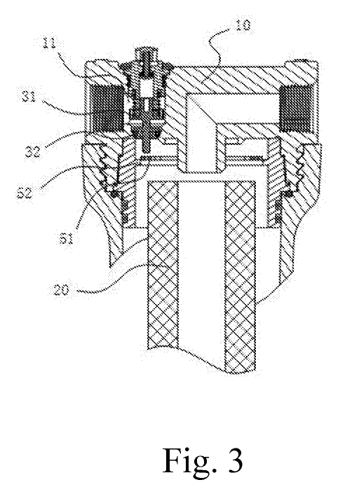

Firstly, refer to FIGS. 1 to 3 respectively for a schematic diagram showing water flow for the pre-filter device capable of preventing water leakage in operation according to the present invention; a perspective view of the pre-filter device capable of preventing water leakage according to the present invention; and another perspective view of the pre-filter device capable of preventing water leakage according to the present invention.

As shown in FIGS. 1 to 3, the present invention provides a pre-filter device capable of preventing water leakage, that includes: a connector 10, a water inlet channel 11, a plug 30, and a spring 40. The connector 10 is connected to a water inlet tube, and is connected to the pre-filter device 20. The water inlet channel 11 is disposed in the connector 10, and is connected to the pre-filter device 20. The plug 30 is disposed in the water inlet channel 11, to open or close the water inlet channel 11. The spring 40 is disposed between one end of the plug 30 and the connector 10, the other end of the plug 30 is connected to and acts in cooperation with the pre-filter device 20. When the pre-filter device 20 capable of preventing water leakage is working normally filtering water, the filter cartridge of the pre-filter device 20 is pressed against the plug 30, to ensure smooth passage of water through the water inlet channel 11. When the pre-filter device is burst to leak out water, the filter cartridge of the pre-filter device 20 is detached, to release the plug 30, to press it downward onto the plug 30 under the actions of the spring 40, to block the water inlet channel 11.

In an embodiment of the present invention, the plug 30 includes a movable rod, and a water stoppage tight seal ring 32 is sleeved around an outer perimeter of one end of the movable rod 31, to act in cooperation with the water inlet channel 11.

In an embodiment of the present invention, the pre-filter device capable of preventing water leakage 20 further includes a press plate 51, disposed between the other end of the movable rod 31 and the pre-filter device 20; and a position restricting protrusion block 52, disposed on the connector 10, to act in cooperation with the press plate 51. As such, when pre-filter device 20 is burst, the press plate 51 will fall downward onto the position restricting protrusion block 52, to prevent the press plate 51 from falling down further, so it can be used again.

In an embodiment of the present invention, the pre-filter device capable of preventing water leakage 20 further includes: a main body 60, disposed on an opening of the connector 10; a fixing pad 61, disposed on the main body 60; and a lock tight bolt 62, disposed on the fixing pad 61.

In an embodiment of the present invention, the pre-filter device capable of preventing water leakage further includes: an air discharge channel 63, a protrusion ring 64, a bolt 65, a tight seal pad 66, and a cover body 67. The air discharge channel 63 is disposed on the main body 60, and is in communication with the water inlet channel 11. The protrusion ring 64 is disposed on the air discharge channel 63. The bolt 65 is disposed on an air discharge port. The tight seal pad 66 is connected to one end of the bolt 65, to act in cooperation with the protrusion ring 64. The cover body 67 is thread-connected to the other end of the bolt 65, and is disposed on an outer side of the connector 10.

In a normal operation of the pre-filter device capable of preventing water leakage, the filter cartridge pushes up the movable rod 31 through first pushing up the press plate 51, such that water enters into the filter cartridge through the water inlet channel, then water flows out of the water outlet port. When the pre-filter device 20 is burst to leak water, the pre-filter device 20 falls down, and the filter cartridge is detached downward. The released press plate 51 falls back onto the position restricting protrusion block 52 on the connector 10. The movable rod 31 having the water stoppage tight seal ring 32 is made to press against and block the water inlet channel 11, due to the restoration action of the spring 40, to close water inlet from the water inlet channel 11.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A pre-filter device capable of preventing water leakage, comprising:
a connector, connected to a water inlet tube, and is connected to the pre-filter device;
a water inlet channel, disposed in the connector, and is connected to the pre-filter device;
a plug, disposed in the water inlet channel, to open or close the water inlet channel; and
a spring, disposed between one end of the plug and the connector, the other end of the plug is connected to and acts in cooperation with the pre-filter device.

2. The pre-filter device capable of preventing water leakage as claimed in claim 1, wherein the plug includes a movable rod, a water stoppage tight seal ring is sleeved around an outer perimeter of one end of the movable rod, to act in cooperation with the water inlet channel.

3. The pre-filter device capable of preventing water leakage as claimed in claim 2, further comprising: a press plate, disposed between the other end of the movable rod and the pre-filter device.

4. The pre-filter device capable of preventing water leakage as claimed in claim 3, further comprising: a position restricting protrusion block, disposed on the connector, to act in cooperation with the press plate.

5. The pre-filter device capable of preventing water leakage as claimed in claim 4, further comprising:
a main body, disposed on an opening of the connector;
a fixing pad, disposed on the main body; and
a lock tight bolt, disposed on the fixing pad.

6. The water storage bottle as claimed in claim 5, further comprising:
an air discharge channel, disposed on the main body, and is in communication with the water inlet channel;
a protrusion ring, disposed on the air discharge channel;
a bolt, disposed on an air discharge port;
a tight seal pad, connected to one end of the bolt, to act in cooperation with the protrusion ring; and
a cover body, thread-connected to the other end of the bolt, and is disposed on an outer side of the connector.
